(19) United States
(12) Patent Application Publication
(10) Pub. No.: US 2015/0167271 A1
(43) Pub. Date: Jun. 18, 2015

(54) Subsea Crane System

(71) Applicants: Roger Walls, Edinburgh (GB); Mark A. Johnson, Houston, TX (US)

(72) Inventors: Roger Walls, Edinburgh (GB); Mark A. Johnson, Houston, TX (US)

(21) Appl. No.: 14/510,900

(22) Filed: Oct. 9, 2014

Related U.S. Application Data
(60) Provisional application No. 61/915,747, filed on Dec. 13, 2013.

(51) Int. Cl. E02D 15/00; B66C 25/00

(52) U.S. Cl. CPC E02D 15/00; B66C 25/00

(57) ABSTRACT

A subsea crane system and a method of installing equipment using the same. In one example, the subsea crane system a plurality of winches positioned adjacent to a seabed and each of the winches has an associated winch line. A buoyancy tank is mechanically connected to each of the winches by the winch lines. A lift line extends from the buoyancy tank and an engagement device is provided at the end of the lift line.

### CROSS REFERENCE TO RELATED APPLICATION

This application claims the benefit of U.S. Provisional Patent Application 61/915,747, filed Dec. 13, 2013, entitled SUBSEA CRANE SYSTEM, the entirety of which is incorporated by reference herein.

### FIELD OF INVENTION

This invention generally relates to the field of installation equipment for oil and gas facilities and, more particularly, to a crane system deployed subsea.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Currently, the installation and maintenance of subsea oil and gas production facilities involves the lifting of individual items of equipment into position by crane, winch, or other device. In conventional systems, such devices are located on a surface vessel, such as, but not limited to, a drilling facility or dedicated construction ship.

A conventional crane-based installation system 100 is depicted in FIG. 1. As depicted, a vessel 101 floats in the water 103. Vessel 101 is equipped with crane 105 which is operable to lift and move equipment 107 near the seabed 109. In the depicted embodiment, equipment 107 is being delivered to a drill center 111.

However, conventional systems, such as the one depicted in FIG. 1, have their deficiencies. In locations in the world where sea ice is present for at least part of the year, such lifting operations will be precluded during that time as vessel 101 is inoperable in such conditions. Thus, there is a need for improvement in this field.

### SUMMARY OF THE INVENTION

The present invention provides a subsea crane system and method of operating the same.

One embodiment of the present disclosure is a subsea crane system comprising: a plurality of winches positioned adjacent to a seabed, each of the plurality of winches having an associated winch line; a buoyancy tank mechanically connected to each of the plurality of winches by the winch lines; a lift line extending from the buoyancy tank; and an engagement device provided at the end of the lift line.

The foregoing has broadly outlined the features of one embodiment of the present disclosure in order that the detailed description that follows may be better understood. Additional features and embodiments will also be described herein.

### BRIEF DESCRIPTION OF THE DRAWINGS

The present invention and its advantages will be better understood by referring to the following detailed description and the attached drawings.

FIG. 1 is a schematic side view of an offshore installation system as known in the prior art.

FIG. 2 is a schematic side view of a subsea crane system according to one embodiment of the present disclosure.

FIG. 3 is a top plan view of the subsea crane system depicted in FIG. 2.

FIG. 4 is a schematic side view of a buoyancy tank and associated equipment according to one embodiment of the present disclosure.

FIG. 5 is a schematic side view of a subsea winch system and associated equipment according to one embodiment of the present disclosure.

FIGS. 6A-6D are schematic side views demonstrating the operation of a subsea crane system according to one embodiment of the present disclosure.

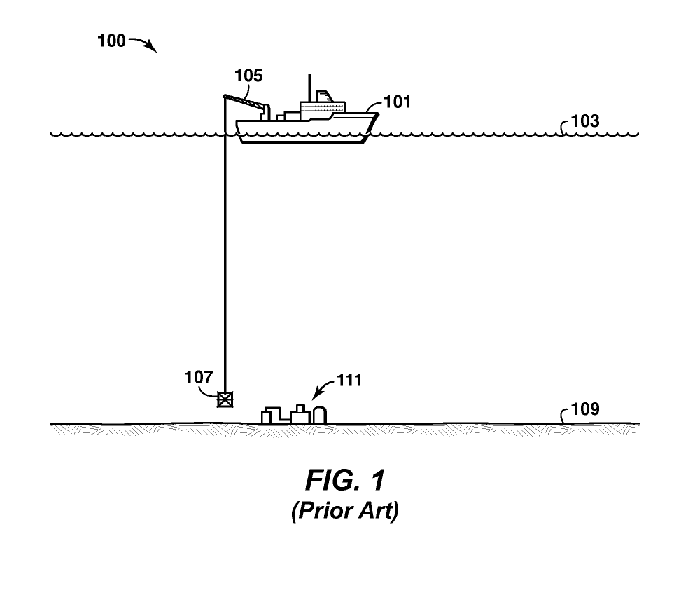

It should be noted that the figures are merely examples of several embodiments of the present invention and no limitations on the scope of the present invention are intended thereby. Further, the figures are generally not drawn to scale, but are drafted for purposes of convenience and clarity in illustrating various aspects of certain embodiments of the invention.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

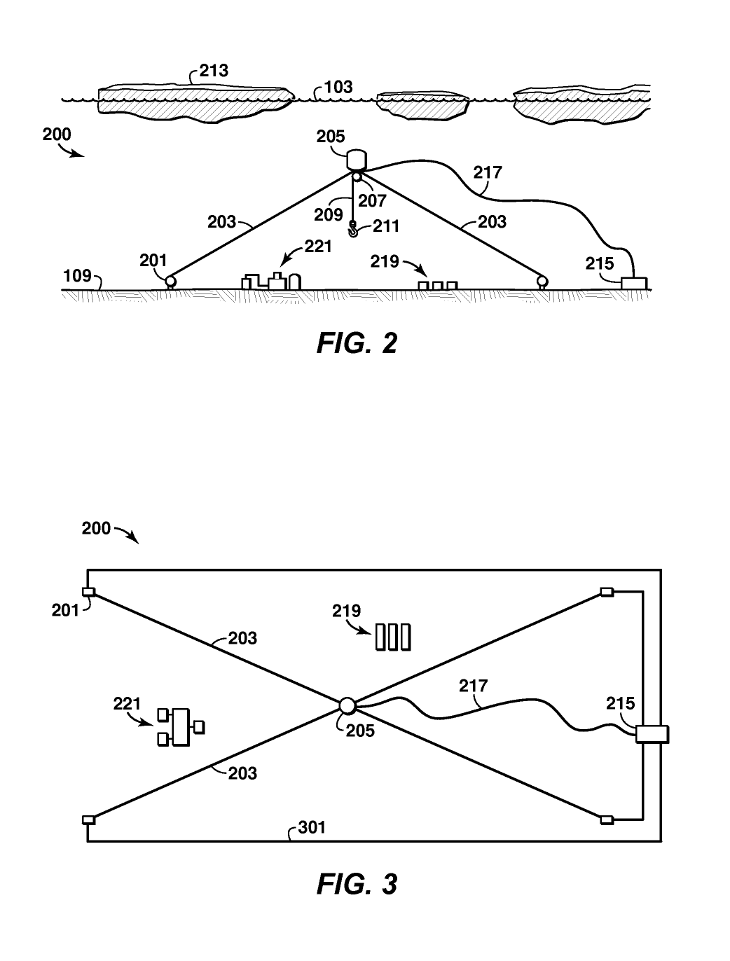

FIG. 2 is a schematic side view of a subsea crane system 200 according to one embodiment of the present disclosure. System 200 comprises a plurality of winches 201 engaged or embedded into the seabed 109. A buoyancy tank 205 is connected to each winch 201 via a winch line 203. A lift winch 207 is provided on the bottom of buoyancy tank 205. Lift winch 207 is operably connected to lifting line 209 which has a hooking member 211 attached at the end. The hooking member 211 is one example of an engagement device.

Through operation of winches 201, winch lines 203 can be retracted or extended thereby altering the depth and/or lateral position of buoyancy tank 205. In the event ice 213 is floating in the water 103 in the area of the subsea crane system 200, buoyancy tank 205 can maintain a depth deep enough to avoid ice 213 while being able to continue its installation and/or maintenance operations.

Operational control of winches 201 and lift winch 207 is provided by control unit 215. In FIG. 2, lift winch 207 is communicatively connected to control unit 215 by lift control line 217. As depicted in FIG. 3, winches 201 are communicatively connected to control unit 215 by winch control line 301. However, winches 201 and 207 may be wirelessly connected to control unit 215. Control unit 215 may also communicate with a top-side control station through known communication techniques.

As noted above, operation of winches 201, at least in part, dictates the depth of buoyancy tank 205 within the water 103. However, operation of winches 201 also determines the lateral movement of the buoyancy tank 205 with respect to the seabed 109. Operation of lift winch 207 provides movement and placement of hooking member 211. Therefore, coordinated operation of winches 201 and lift winch 207 enable movement of subsea equipment 219 from one location to another, such as drill center 221, even in the presence of ice 213. FIG. 3 is a top plan view of the subsea crane system depicted in FIG. 2.

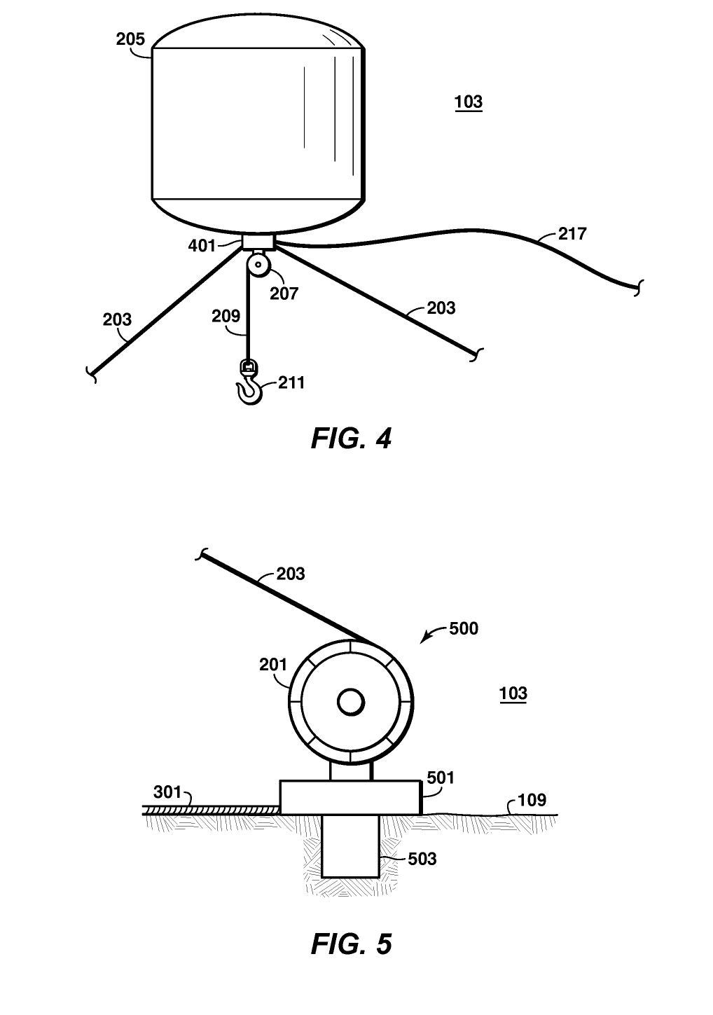

FIG. 4 is a schematic side view of buoyancy tank 205. As depicted, a base member 401 is provided on the underside of buoyancy tank 205. The base member 401 provides a fixation point for the subsea winch lines 203 as well as lift winch 207. Base member 401 may be formed as part of the buoyancy tank 205 or as a separate component which is affixed to the buoyancy tank 205. Lift control line 217 is also connected to base member 401 enabling control signals to be provided to lift winch 207.

FIG. 5 is a schematic side view of a subsea winch system 500. As depicted, a base portion 501 is provided adjacent to the seabed 109 to provide a support structure for winch 201. As depicted, base portion 501 is held in place by pile 503 which is embedded into the seabed 109. Winch control line 301 is connected to base 501 enabling control signals to be provided to winch 201. Base portion 501 and winch 201 may be a single unit or composed as multiple unites affixed together.

As described herein, subsea crane system 200 utilizes a large buoyancy tank 205 held below the sea surface and maneuvered around a drill center 221 by a number of subsea winches 201 mounted on the seabed 109. The subsea crane system 200 may be a fixture at a subsea drill/facilities center and may be powered from a local electrical supply. In some embodiments, the subsea crane system 200 may be powered by the same source that provides power to the subsea production equipment. Though not necessary, the subsea crane system 200 may operate with assistance from a Remotely Operated Vehicle (ROV) similar to conventional installation systems.

The subsea crane system 200 may be installed through a conventional installation system using traditional techniques, i.e. with a surface vessel, at a time when there was no ice covering the sea. Similarly, the individual items of equipment 219 to be lifted by the subsea crane system 200 at some later time are placed on the seabed 109 at a pre-designated ‘wet park’ location at a time when there is access with conventional crane/lifting equipment.

The size of the buoyancy tank 205 depends on a number of variables, including, but not limited to, the weight of the loads to be carried and the individual field layout. In one embodiment, buoyancy tank 205 has a maximum net buoyancy of 50 Te. The buoyancy tank may have a minimum net buoyancy of 5 T. The buoyancy tank 205 may include a lift winch 207 to raise and lower the load lift line 209 directly. The buoyancy tank 205 may include floodable compartments to enable the level of buoyancy to be varied to suit.

As described herein, the seabed winches 201 are used to control the position of the buoyancy tank 205 and maneuver it around the drill center 221. The number and capacity rating of the winches 201 are determined by the field layout and weight of loads to be carried as well as possibly by the need to have redundancy in the system in order to gain better system reliability. Each seabed winch 201 is mounted upon a pile 503 that maintains its fixed position during the lifting and moving operations of the crane.

The winches are powered through known techniques, such as, but not limited to, electric or hydraulic power. In the case of hydraulically powered winches, a Hydraulic Power Unit (HPU) is located close to the subsea crane system, more particularly winches 201 and lift winch 207. Electrical power, either to drive the winches directly, or to drive the HPU, may be supplied more remotely. The winches 201 and 207 may be controlled individually and directly by a dedicated control unit 215. The control unit 215 may comprise several sub-units to enable interfaces with other equipment and/or a high level of automation. The control unit 215 may comprise a communication module to receive operator instructions.

A hook 211 is attached to the bottom of the lifting line 209 so that the crane system can be connected or disconnected from the equipment 219. The hook 211 may be connected or disconnected with ROV assistance. Hooks 211 are standard and known to those skilled in the art.

Pile 503 may utilize known techniques to embed into the seabed. Pile 503 may be a suction pile, gravity base foundation, or otherwise driven pile.

As depicted, the buoyancy tank 205 may include a lift winch 207 to facilitate rising and lowering the load. However, lift winch 207 is not necessary and the lifting line 209 may be, instead, statically connected to buoyancy tank 205. The buoyancy tank 205 may be designed to have variable buoyancy through use of separate floodable compartments.

The winches 201 used to maneuver the buoyancy tank 205 around the drill center 221 may be individually controllable. The control system may use a combination of pre-programmed operations, e.g., ‘forward’, ‘back’, ‘left’, ‘right’, or even instruct the buoyancy tank to be moved to pre-set locations, as well as live position feedback in order to provide simplified and steady maneuvering operations with minimal likelihood of collisions. A human interface module for the control system may be provided in the same room as the ROV pilot, thus enabling close cooperation and coordination between the two.

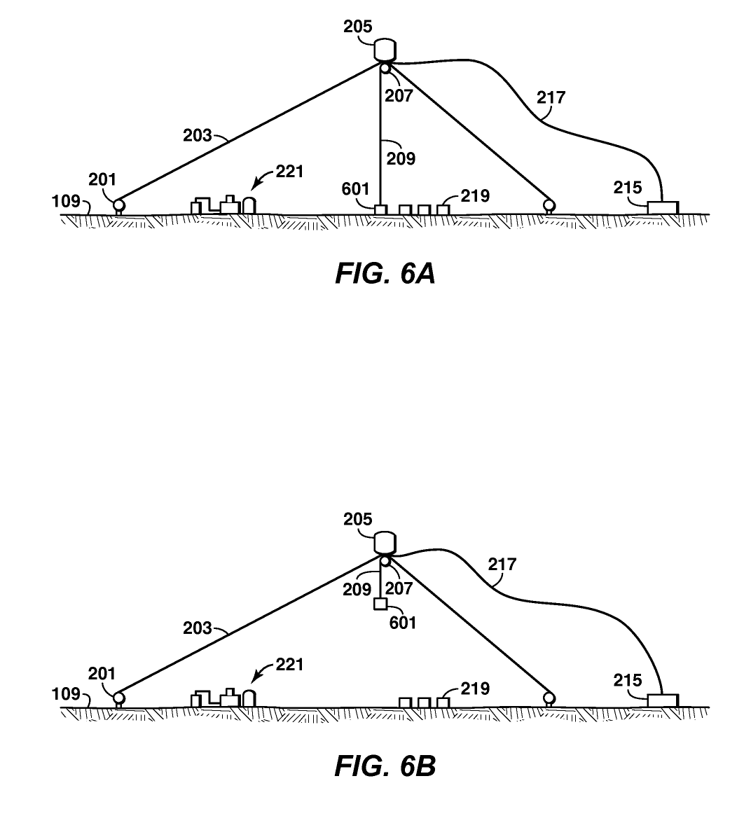

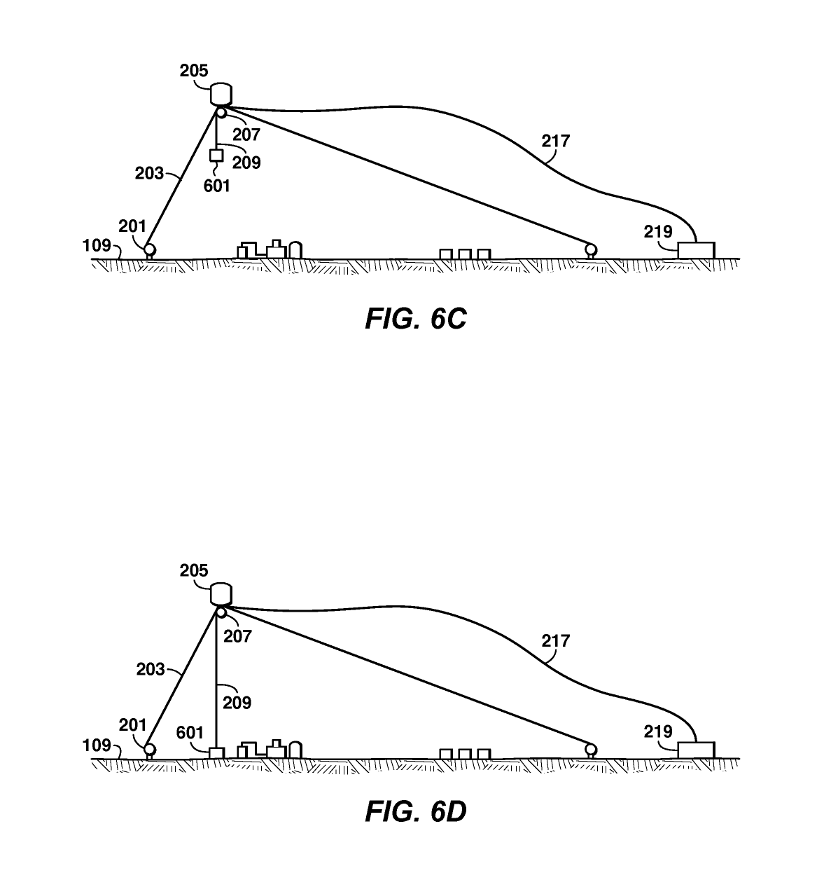

FIGS. 6A-6D are schematic side views demonstrating the operation of a subsea crane system according to one embodiment of the present disclosure. As depicted in FIG. 6A, buoyancy tank 205 is moved into a position above the item of equipment 601 to be installed and the lifting wire 209 lowered through operation of lift winch 207. An ROV may then be used to place the hooking member 211 (not depicted) onto a shackle, lifting eye, or other attachment apparatus on the selected equipment 601.

Turning now to FIG. 6B, equipment 601 is then lifted up to a height sufficient to clear existing seabed equipment 221 using the lifting winch 207 on the buoyancy tank 205. In FIG. 6C, winches 201 are operated in such a way to maneuver the buoyancy tank 205 and equipment 601 from a position above the wet park area to its final installation location. As the equipment 601 is lowered into its final position, as in FIG. 6D, the ROV may be used to provide a visual and/or physical guide where precision relative positioning is required. Such ROV supporting operations are known for this type of activity. Finally, the ROV may be used to detach the lifting line hook 211 from the equipment 601 thus releasing the subsea crane system.

Though described herein in the context of construction for installation, the subsea crane system may be used for a variety of underwater operations, such as, but not limited to, maintenance activities where the lifting of heavy equipment is required. In such instances, similar processes as previously described would be utilized, possibly with the assistance of specialist tooling constructed and arranged to remove failed equipment to the wet park area.

The subsea crane system described herein accomplishes the identical functionality of a standard vessel mounted crane; however, the subsea crane system operates without requiring any support from a vessel on the sea surface.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A subsea crane system comprising:
a plurality of winches positioned adjacent to a seabed, each of the plurality of winches having an associated winch line;
a buoyancy tank mechanically connected to each of the plurality of winches by the winch lines;
a lift line extending from the buoyancy tank; and
an engagement device provided at the end of the lift line.

2. The system of claim 1 further comprising a lift winch positioned on the buoyancy tank, the lift winch is constructed and arranged to control the depth of the engagement device by adjusting a deployed length of the lift line.

3. The system of claim 2 further comprising a control unit communicatively connected to each of the plurality of winches and the lift winch.

4. The system of claim 3 wherein the control unit comprises a communication module constructed and arranged to receive command signals.

5. The system of claim 2 further comprising a hydraulic power unit operatively connected to the plurality of winches and the lift winch.

6. The system of claim 1 further comprising a base portion associated with each of the plurality of winches, each base portion having an associated pile constructed and arranged to embed into the seabed.

7. The system of claim 6, wherein the pile is a suction pile.

8. The system of claim 1, wherein the buoyancy tank comprises a plurality of floodable components.

9. The system of claim 1, wherein the engagement device is constructed and arranged to attach to subsea equipment placed on the seabed.

10. A method of installing equipment comprising:
providing a subsea crane system comprising:
a plurality of winches positioned adjacent to a seabed, each of the plurality of winches having an associated winch line;
a buoyancy tank mechanically connected to each of the plurality of winches by the winch lines;
a lift line extending from the buoyancy tank; and
an engagement device provided at the end of the lift line;
operating at least one of the plurality of winches to move the buoyancy tank in a position over a piece of equipment adjacent to the seabed;
connecting the lift line to the piece of equipment with the engagement device; and
operating at least one of the plurality of winches to move the buoyancy tank and the piece of equipment into an installed position.

11. The method of claim 10, wherein the subsea crane system further comprises a lift winch positioned on the buoyancy tank, the lift winch is constructed and arranged to control the depth of the engagement device by adjusting a deployed length of the lift line.

12. The method of claim 11 further comprising operating the lift winch to adjust a deployed length of the lift line.

13. The method of claim 10, wherein the operation of at least one of the plurality of winches adjusts a depth of the buoyancy tank.

14. The method of claim 10, wherein the operation of at least one of the plurality of winches adjusts the lateral position of the buoyancy tank with respect to the seabed.
